(19) United States
(12) Patent Application Publication
(10) Pub. No.: US 2020/0148834 A1
(43) Pub. Date: May 14, 2020

(54) CARBONATE-OLEFIN COPOLYMER

(71) Applicant: IDEMITSU KOSAN CO., LTD., Tokyo (JP)

(72) Inventors: Aki YAMADA, Sodegaura-shi, Chiba (JP); Koichi SUGA, Sodegaura-shi, Chiba (JP)

(73) Assignee: IDEMITSU KOSAN CO., LTD., Tokyo (JP)

(21) Appl. No.: 16/633,126

(22) PCT Filed: Jul. 26, 2018
(86) PCT No.: PCT/JP2018/028022

§ 371 Date: Jan. 22, 2020

(30) Foreign Application Priority Data
Jul. 28, 2017 (JP) 2017-146804

(51) Int. Cl. C08G 81/02

(52) U.S. Cl. CPC C08G 81/027

(57) ABSTRACT

Provided is a carbonate-olefin-based copolymer including a polycarbonate block, an olefin-based polymer block, and a specific constituent unit.

### TECHNICAL FIELD

The present invention relates to a carbonate-olefin-based copolymer excellent in scratch resistance and a molded article including the copolymer.

### BACKGROUND ART

In recent years, there has been a growing demand for an improvement in scratch resistance of a thermoplastic resin. For example, a polycarbonate has characteristics such as excellent transparency, excellent heat resistance, and excellent mechanical characteristics, and hence has been used in a wide variety of applications including casings for OA equipment and household electric appliances, members in electrical and electronic fields, and optical materials for lenses. However, the polycarbonate has a low surface hardness, and hence has a drawback in that the polycarbonate is liable to flaw.

To alleviate the drawback, for example, the following has been proposed (see, for example, Patent Document 1). An acrylic polymer that is a transparent resin is blended into the polycarbonate to improve the surface hardness while maintaining the transparency.

### CITATION LIST

### Patent Document

Patent Document 1: JP 06-256494 A

### SUMMARY OF INVENTION

### Technical Problem

It is hard to say that, when the method of Patent Document 1 is used, sufficiently satisfactory scratch resistance can be expressed while the excellent characteristics of the polycarbonate are retained.

The present invention has been made in view of the above-mentioned circumstances, and an object of the present invention is to provide a carbonate-olefin-based copolymer having excellent scratch resistance while retaining excellent characteristics of a polycarbonate, and a molded article including the copolymer.

### Solution to Problem

The inventors have made extensive investigations, and as a result, have found that the above-mentioned problem can be solved by a carbonate-olefin-based copolymer obtained by linking a polycarbonate block and an olefin-based polymer block through a constituent unit having a specific structure.

That is, the present invention is an invention relating to the following carbonate-olefin-based copolymer and a molded article including the copolymer.

1. A carbonate-olefin-based copolymer, comprising:

a polycarbonate block having a repeating unit represented by the following general formula (I);

an olefin-based polymer block having a repeating unit represented by the following general formula (II); and

a constituent unit represented by the following general formula (III):

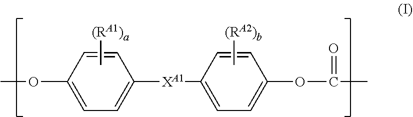

wherein

in the formula (I), R^{A1} and R^{A2} each independently represent a halogen atom, an alkyl group having 1 to 6 carbon atoms, or an alkoxy group having 1 to 6 carbon atoms, X^{A1} represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, and “a” and “b” each independently represent an integer of from 0 to 4, and when a plurality of R_{A1}s or R^{A2}s are present, the plurality of R^{A1}s or R^{A2}s may be identical to or different from each other;

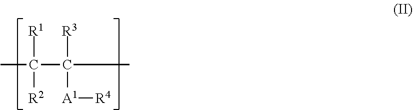

wherein

in the formula (II), R¹, R², R³, and R⁴ each independently represent a hydrogen atom or a hydrocarbon group having 1 to 12 carbon atoms, and A¹ represents a single bond, a carbonyloxy group, or an oxycarbonyl group;

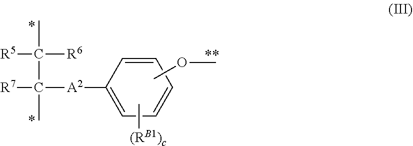

wherein

in the formula (III), R⁵, R⁶, and R⁷ each independently represent a hydrogen atom, an alkyl group having 1 to 6 carbon atoms, or an aryl group having 6 to 12 carbon atoms, R^{B1} represents a halogen atom, an alkyl group having 1 to 6 carbon atoms, or an alkoxy group having 1 to 6 carbon atoms, “c” represents an integer of from 0 to 4, A² represents a single bond or a divalent group represented by the following formula (III-d), at least one of bonding sites each represented by * is bonded to the olefin-based polymer block, and a bonding site represented by ** is bonded to the polycarbonate block;

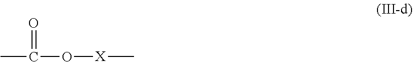

wherein

in the formula (III-d), X represents a single bond, an alkyleneoxy group having 1 to 12 carbon atoms, an arylene group having 6 to 12 carbon atoms, a divalent group represented by the following formula (III-a), or a divalent group represented by the following formula (III-b);

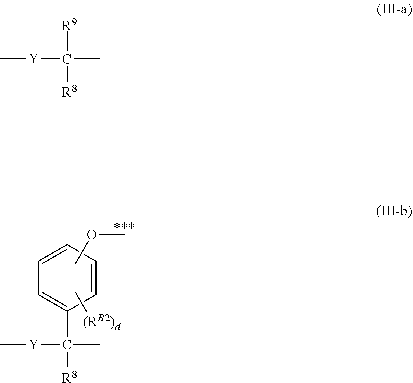

wherein

in the formulae (III-a) and (III-b), R⁸ and R⁹ each independently represent a hydrogen atom, an alkyl group having 1 to 6 carbon atoms, or an aryl group having 6 to 12 carbon atoms, Y represents a single bond, an alkylene group having 1 to 12 carbon atoms, or a divalent group represented by the following formula (III-c), R^{B2} represents a halogen atom, an alkyl group having 1 to 6 carbon atoms, or an alkoxy group having 1 to 6 carbon atoms, “d” represents an integer of from 0 to 4, and a bonding site represented by *** is bonded to the polycarbonate block, or is bonded to a hydrogen atom or a monovalent organic group;

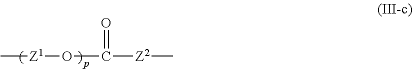

wherein

in the formula (III-c), Z¹ represents an alkylene group having 1 to 12 carbon atoms, Z² represents a single bond or an alkylene group having 1 to 12 carbon atoms, and “p” represents an integer of from 1 to 10.

2. The carbonate-olefin-based copolymer according to the above-mentioned item 1, wherein a total content of the repeating unit represented by the general formula (II) and a moiety derived from an alkenyl group of the constituent unit represented by the general formula (III) in the carbonate-olefin-based copolymer is from 5 mass % to 90 mass %.

3. The carbonate-olefin-based copolymer according to the above-mentioned item 1 or 2, wherein a ratio of the constituent unit represented by the general formula (III) to a total of the repeating unit represented by the general formula (II) and the constituent unit represented by the general formula (III) is from 0.01 mol % to 20 mol %.

4. The carbonate-olefin-based copolymer according to any one of the above-mentioned items 1 to 3, wherein a molar ratio [constituent unit (III)/repeating unit (I)] of the constituent unit represented by the general formula (III) to the repeating unit represented by the general formula (I) is from 0.1/99.9 to 50/50.

5. The carbonate-olefin-based copolymer according to any one of the above-mentioned items 1 to 4, wherein the constituent unit represented by the general formula (III) is represented by the following formula (III-1):

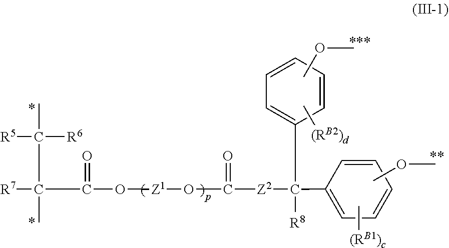

wherein

in the formula (III-1), R⁵, R⁶, R⁷, R⁸, R^{B1}, R^{B2}, Z¹, Z², “c”, “d”, “p”, *, **, and *** each have the same meaning as that described above.

6. The carbonate-olefin-based copolymer according to any one of the above-mentioned items 1 to 5, wherein the olefin-based polymer block contains a (meth)acrylic polymer block having a repeating unit represented by the following general formula (IV):

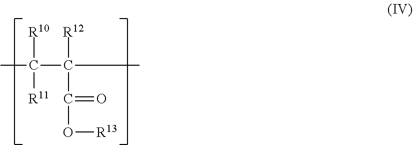

wherein

in the formula (IV), R¹⁰, R¹¹, R¹², and R¹³ each independently represent a hydrogen atom, an alkyl group having 1 to 6 carbon atoms, or an aryl group having 6 to 12 carbon atoms.

7. The carbonate-olefin-based copolymer according to any one of the above-mentioned items 1 to 6, wherein the carbonate-olefin-based copolymer has a viscosity-average molecular weight of from 10,000 to 80,000.

8. The carbonate-olefin-based copolymer according to any one of the above-mentioned items 1 to 7, wherein a number of repetitions of the repeating unit represented by the general formula (I) in the carbonate-olefin-based copolymer is from 29 to 79.

9. The carbonate-olefin-based copolymer according to any one of the above-mentioned items 1 to 8, wherein the carbonate-olefin-based copolymer comprises a copolymer of a modified olefin-based polymer having the repeating unit represented by the general formula (II) and the constituent unit represented by the general formula (III), and a polycarbonate having the repeating unit represented by the general formula (I).

10. The carbonate-olefin-based copolymer according to the above-mentioned item 9, wherein the modified olefin-based polymer has a number-average molecular weight (Mn) of from 3,000 to 50,000.

11. A molded article, comprising the carbonate-olefin-based copolymer of any one of the above-mentioned items 1 to 10.

### ADVANTAGEOUS EFFECTS OF INVENTION

The molded article including the carbonate-olefin-based copolymer of the present invention has excellent scratch resistance while retaining excellent characteristics of a polycarbonate resin.

### BRIEF DESCRIPTION OF DRAWINGS

FIG. 1 is an NMR chart for showing the structure of a modified (meth)acrylic monomer in Synthesis Example 1.

FIG. 2 is an NMR chart for showing the structure of a modified (meth)acrylic polymer in Production Example 1.

FIG. 3 is an NMR chart for showing the structure of a carbonate-olefin-based copolymer in Example 1.

FIG. 4 is an illustration of the DSC curve of the carbonate-olefin-based copolymer in Example 1.

### DESCRIPTION OF EMBODIMENTS

### Carbonate-olefin-Based Copolymer

A carbonate-olefin-based copolymer of the present invention includes: a polycarbonate block having a repeating unit represented by the general formula (I); an olefin-based polymer block having a repeating unit represented by the general formula (II); and a constituent unit represented by the general formula (III).

The carbonate-olefin-based copolymer of the present invention is described below. In this description, a specification considered to be preferred may be arbitrarily adopted, and a combination of preferred specifications can be said to be more preferred. The term “XX to YY” as used herein means “from XX or more to YY or less.”

### Polycarbonate Block

The carbonate-olefin-based copolymer of the present invention includes the polycarbonate block having the repeating unit represented by the following general formula (I) (sometimes simply referred to as “polycarbonate block”). The main chain of the polycarbonate block preferably has the repeating unit represented by the following general formula (I).

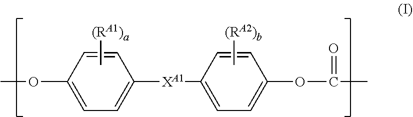

In the formula (I), R^{A1} and R^{A2} each independently represent a halogen atom, an alkyl group having 1 to 6 carbon atoms, or an alkoxy group having 1 to 6 carbon atoms, X^{A1} represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, and “a” and “b” each independently represent an integer of from 0 to 4, and when a plurality of R^{A1}s or R^{A2}s are present, the plurality of R^{A1}s or R^{A2}s may be identical to or different from each other.

A block produced by a known method may be used as the polycarbonate block in the present invention without any particular limitation.

For example, a block produced from a dihydric phenol and a carbonate precursor by a solution method (interfacial polycondensation method) or a melting method (ester exchange method), that is, a block, which is produced by the interfacial polycondensation method involving causing the dihydric phenol and the carbonate precursor, such as phosgene, to react with each other in the presence of a terminal stopper, or by causing the dihydric phenol and the carbonate precursor, such as diphenyl carbonate, to react with each other on the basis of the ester exchange method or the like in the presence of the terminal stopper, may be used.

Although the dihydric phenol for forming the main chain of the polycarbonate block in the present invention is not particularly limited, a dihydric phenol represented by the following general formula (1), the phenol forming the repeating unit represented by the general formula (I), is preferably used.

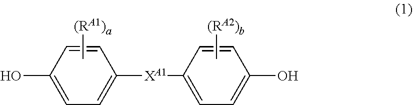

In the formula (1), R^{A1}, R^{A2}, X^{A1}, “a”, and “b” each have the same meaning as that described above.

Examples of the halogen atom represented by any one of R^{A1} and R^{A2} include a fluorine atom, a chlorine atom, a bromine atom, and an iodine atom. Examples of the alkyl group having 1 to 6 carbon atoms, which is represented by any one of R^{A1} and R^{A2}, include a methyl group, an ethyl group, a n-propyl group, an isopropyl group, various butyl groups (the term “various” means that a linear group and any branched group are included, and the same holds true for the following), various pentyl groups, and various hexyl groups. The alkoxy group having 1 to 6 carbon atoms, which is represented by any one of R^{A1} and R^{A2}, is, for example, an alkoxy group whose alkyl group moiety having 1 to 6 carbon atoms is the alkyl group described above.

R^{A1} and R^{A2} each preferably represent an alkyl group having 1 to 4 carbon atoms, or an alkoxy group having 1 to 4 carbon atoms.

Examples of the alkylene group having 1 to 8 carbon atoms, which is represented by X^{A1}, include a methylene group, an ethylene group, a trimethylene group, a tetramethylene group, and a hexamethylene group. Among them, an alkylene group having 1 to 5 carbon atoms is preferred. Examples of the alkylidene group having 2 to 8 carbon atoms, which is represented by X^{A1}, include an ethylidene group and an isopropylidene group. Examples of the cycloalkylene group having 5 to 15 carbon atoms, which is represented by X^{A1}, include a cyclopentanediyl group, a cyclohexanediyl group, and a cyclooctanediyl group. Among them, a cycloalkylene group having 5 to 10 carbon atoms is preferred. Examples of the cycloalkylidene group having 5 to 15 carbon atoms, which is represented by X^{A1}, include a cyclohexylidene group, a 3,5,5-trimethylcyclohexylidene group, and a 2-adamantylidene group. Among them, a cycloalkylidene group having 5 to 10 carbon atoms is preferred, and a cycloalkylidene group having 5 to 8 carbon atoms is more preferred. Examples of aryl moieties of the arylalkylene group having 7 to 15 carbon atoms and the arylalkylidene group having 7 to 15 carbon atoms, each of which is represented by X^{A1}, include aryl groups each having 6 to 14 ring-forming carbon atoms, such as a phenyl group, a naphthyl group, a biphenyl group, and an anthryl group.

“a” and “b” each independently represent an integer of from 0 to 4, preferably from 0 to 2, more preferably 0 or 1.

Examples of the dihydric phenol represented by the general formula (1) include: bis(hydroxyaryl)alkanes, such as bis(4-hydroxyphenyl)methane,
1,1-bis(4-hydroxyphenyl)ethane, 2,2-bis(4-hydroxyphenyl)propane,
2,2-bis(4-hydroxyphenyl)butane, 2,2-bis(4-hydroxyphenyl)octane,
2,2-bis(4-hydroxyphenyl)phenylmethane,
2,2-bis(4-hydroxy-1-methylphenyl)propane,
bis(4-hydroxyphenyl)naphthylmethane, 1,1-bis(4-hydroxy-t-butylphenyl)propane,
2,2-bis(4-hydroxy-3-bromophenyl)propane,
2,2-bis(4-hydroxy-3,5-dimethylphenyl)propane,
2,2-bis(4-hydroxy-3-chlorophenyl)propane,
2,2-bis(4-hydroxy-3,5-dichlorophenyl)propane, and
2,2-bis(4-hydroxy-3,5-dibromophenyl)propane; bis(hydroxyaryl)cycloalkanes, such as 1,1-bis(4-hydroxyphenyl)cyclopentane,
1,1-bis(4-hydroxyphenyl)cyclohexane, and
1,1-bis(4-hydroxyphenyl)-3,5,5-trimethylcyclohexane; dihydroxyaryl ethers, such as 4,4′-dihydroxyphenyl ether and 4,4′-dihydroxy-3,3′-dimethylphenyl ether;
dihydroxydiaryl sulfides, such as 4,4′-dihydroxydiphenyl sulfide and
4,4′-dihydroxy-3,3′-dimethyldiphenyl sulfide; dihydroxydiaryl sulfoxides, such as
4,4′-dihydroxydiphenyl sulfoxide and 4,4′-dihydroxy-3,3′-dimethyldiphenyl sulfoxide; dihydroxydiaryl sulfones, such as 4,4′-dihydroxydiphenyl sulfone and
4,4′-dihydroxy-3,3′-dimethyldiphenyl sulfone; dihydroxydiphenyls, such as
4,4′-dihydroxydiphenyl; dihydroxydiarylfluorenes, such as
9,9-bis(4-hydroxyphenyl)fluorene and
9,9-bis(4-hydroxy-3-methylphenyl)fluorene; dihydroxydiaryladamantanes, such as 1,3-bis(4-hydroxyphenyl)adamantane, 2,2-bis(4-hydroxyphenyl)adamantane, and 1,3-bis(4-hydroxyphenyl)-5,7-dimethyladamantane;
bis(4-hydroxyphenyl)diphenylmethane;
4,4′-[1,3-phenylenebis(1-methylethylidene)]bisphenol;
10,10-bis(4-hydroxyphenyl)-9-anthrone;
1,5-bis(4-hydroxyphenylthio)-2,3-dioxapentaene; and an
α,ω-bishydroxyphenylpolydimethylsiloxane compound. The dihydric phenols may be used alone or in combination thereof.

Among the dihydric phenols, 2,2-bis(4-hydroxyphenyl)propane [common name: bisphenol A] is suitable.

Examples of the carbonate precursor to be used in the present invention may include a carbonyl halide, a carbonic acid diester, and a haloformate. Specific examples thereof include phosgene, a dihaloformate of a dihydric phenol, diphenyl carbonate, dimethyl carbonate, and diethyl carbonate. Among them, phosgene to be used in the interfacial polymerization method is preferred. The carbonate precursors may be used alone or in combination thereof.

In the present invention, the polycarbonate block may have a branched structure. As a branching agent, there are given, for example,
1,1,1-tris(4-hydroxyphenyl)ethane,
α,α′,α″-tris(4-hydroxyphenyl)-1,3,5-triisopropylbenzene, phloroglucin, trimellitic acid, and 1,3-bis(o-cresol).

The terminal stopper is not particularly limited as long as the terminal stopper is a monohydric phenol, and examples thereof include phenol,
o-n-butylphenol, m-n-butylphenol, p-n-butylphenol, o-isobutylphenol,
m-isobutylphenol, p-isobutylphenol, o-t-butylphenol, m-t-butylphenol,
p-t-butylphenol, o-n-pentylphenol, m-n-pentylphenol, p-n-pentylphenol,
o-n-hexylphenol, m-n-hexylphenol, p-n-hexylphenol, p-t-octylphenol,
o-cyclohexylphenol, m-cyclohexylphenol, p-cyclohexylphenol, o-phenylphenol,
m-phenylphenol, p-phenylphenol, o-n-nonylphenol, m-n-nonylphenol,
p-n-nonylphenol, o-cumylphenol, m-cumylphenol, p-cumylphenol,
o-naphthylphenol, m-naphthylphenol, p-naphthylphenol, 2,5-di-t-butylphenol,
2,4-di-t-butylphenol, 3,5-di-t-butylphenol, 2,5-dicumylphenol, 3,5-dicumylphenol,
p-cresol, a monoalkyl phenol having a linear or branched alkyl group having an average number of carbon atoms of from 12 to 35 at the ortho-, meta-, or
para-position, 3-pentadecylphenol,
9-(4-hydroxyphenyl)-9-(4-methoxyphenyl)fluorene,
9-(4-hydroxy-3-methylphenyl)-9-(4-methoxy-3-methylphenyl)fluorene, and 4-(1-adamantyl)phenol.

Among them, p-t-butylphenol, p-cumylphenol, and p-phenylphenol are preferred, and p-t-butylphenol is more preferred. The terminal stoppers may be used alone or in combination thereof.

In addition, the polycarbonate block in the present invention may have, for example, a constituent unit represented by the following general formula (I-1). When the polycarbonate block has the constituent unit represented by the following general formula (I-1), the fluidity of the carbonate-olefin-based copolymer can be improved.

The constituent unit represented by the following general formula (I-1) may be formed by using a phenol-modified diol represented by the following general formula (1-1).

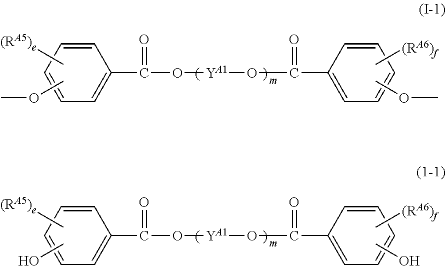

In the general formula (I-1) and the general formula (1-1), R^{A5} and R^{A6} each independently represent an alkyl group having 1 to 3 carbon atoms, Y^{A1} represents a linear or branched alkylene group having 2 to 15 carbon atoms, “e” and “f” each independently represent an integer of from 0 to 4, and “m” represents an integer of from 2 to 200, and when a plurality of R^{A5}s or R^{A6}s are present, the plurality of R^{A5}s or R^{A6}s may be identical to or different from each other.

The phenol-modified diol represented by the general formula (1-1) is, for example, a compound derived from hydroxybenzoic acid, or an alkyl ester or acid chloride thereof and a polyether diol. The phenol-modified diol may be synthesized by a method proposed in, for example, JP 62-79222 A, JP 60-79072 A, or JP 2002-173465 A, and the phenol-modified diol obtained by any such method is desirably purified as appropriate. A method for the purification is desirably, for example, a method involving reducing a pressure in a system in the latter stage of the reaction and removing an excess raw material (such as p-hydroxybenzoic acid) by distillation, or a method involving washing the phenol-modified diol with water, an alkali aqueous solution (such as an aqueous solution of sodium hydrogen carbonate), or the like.

Further, the polycarbonate block in the present invention may be, for example, a copolymer having the repeating unit represented by the general formula (I) and a constituent unit represented by the following general formula (I-2). The constituent unit represented by the following general formula (I-2) may be formed by using a polyorganosiloxane represented by the following general formula (1-2).

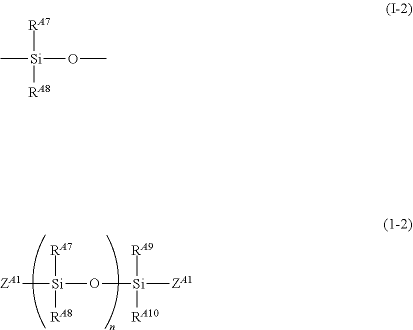

In the general formula (I-2) or the general formula (1-2), R^{A7}, R^{A8}, R^{A9}, and R^{A10} each independently represent a hydrogen atom, a halogen atom, an alkyl group having 1 to 6 carbon atoms, an alkoxy group having 1 to 6 carbon atoms, or an aryl group having 6 to 12 carbon atoms, Z^{A1} represents a phenol residue having a trimethylene group, which is derived from a phenol compound having an allyl group, and “n” represents from 19 to 1,000.

When a copolymer having the constituent unit represented by the general formula (I-2) is used as the polycarbonate block as described above, the flame retardancy of the carbonate-olefin-based copolymer can be improved.

The polyorganosiloxane represented by the general formula (1-2) is obtained by modifying a terminal of a polyorganosiloxane having a hydrogen atom at the terminal with a phenol compound having an allyl group, such as 2-allylphenol or eugenol. A polyorganosiloxane having a terminal modified with a phenol compound having an allyl group may be synthesized by, for example, a method described in JP 2014-80462 A.

The polyorganosiloxane is preferably such a polyorganosiloxane that R^{A7}, R^{A8}, R^{A9}, and R^{A10} in the general formula (1-2) each represent a methyl group.

In the present invention, the polycarbonate block preferably contains a polycarbonate block having a bisphenol A structure from the viewpoints of, for example, the transparency, mechanical characteristics, and thermal characteristics of a molded body to be obtained. Specifically, such a block that, in the general formula (I), “a” and “b” each represent 0, and X^{A1} represents a single bond or an alkylene group having 1 to 8 carbon atoms, or such a block that, in the general formula (I), “a” and “b” each represent 0, and X^{A1} represents an alkylene group having 3 carbon atoms, in particular, an isopropylidene group is suitable as the polycarbonate block having a bisphenol A structure. The content of the polycarbonate block having a bisphenol A structure in the polycarbonate block is preferably from 50 mass % to 100 mass %, more preferably from 75 mass % to 100 mass %, still more preferably from 85 mass % to 100 mass %.

### Olefin-Based Polymer Block

The carbonate-olefin-based copolymer of the present invention includes the olefin-based polymer block having the repeating unit represented by the following general formula (II) (sometimes simply referred to as “repeating unit (II)”) (sometimes simply referred to as “olefin-based polymer block”).

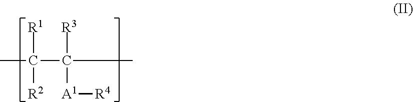

In the formula (II), R¹, R², R³, and R⁴ each independently represent a hydrogen atom or a hydrocarbon group having 1 to 12 carbon atoms, and A¹ represents a single bond, a carbonyloxy group, or an oxycarbonyl group.

The hydrocarbon group having 1 to 12 carbon atoms, which is represented by any one of R¹, R², R³, and R⁴, is, for example, a saturated aliphatic hydrocarbon group having 1 to 12 carbon atoms, an unsaturated aliphatic hydrocarbon group having 2 to 12 carbon atoms, or an aromatic hydrocarbon group having 6 to 12 carbon atoms. The saturated aliphatic hydrocarbon group and the unsaturated aliphatic hydrocarbon group are preferably linear or branched, and are more preferably linear.

The saturated aliphatic hydrocarbon group having 1 to 12 carbon atoms is, for example, an alkyl group having 1 to 12 carbon atoms. Examples of the alkyl group having 1 to 12 carbon atoms include a methyl group, an ethyl group, a propyl group, various butyl groups, various pentyl groups, various hexyl groups, various heptyl groups, various octyl groups, various nonyl groups, various decyl groups, and various dodecyl groups. Examples of the unsaturated aliphatic hydrocarbon group having 2 to 12 carbon atoms include a vinyl group, various butenyl groups, various hexenyl groups, various heptenyl groups, various octenyl groups, various nonenyl groups, various decenyl groups, and various dodecenyl groups. Examples of the aromatic hydrocarbon group having 6 to 12 carbon atoms include an aryl group having 6 to 12 carbon atoms and an aralkyl group having 7 to 12 carbon atoms. Examples of the aryl group having 6 to 12 carbon atoms include a phenyl group, a tolyl group, a xylyl group, a naphthyl group, and a biphenyl group, and examples of the aralkyl group having 7 to 12 carbon atoms include a benzyl group, a phenethyl group, a naphthylmethyl group, a methylbenzyl group, a methylphenethyl group, and a methylnaphthylmethyl group.

R¹, R², R³, and R⁴ each independently represent preferably a hydrogen atom, an alkyl group having 1 to 6 carbon atoms, an aryl group having 6 to 12 carbon atoms, or an aralkyl group having 7 to 12 carbon atoms, more preferably a hydrogen atom, an alkyl group having 1 to 6 carbon atoms, or an aryl group having 6 to 12 carbon atoms.

A¹ preferably represents a single bond or a carbonyloxy group, and more preferably represents a carbonyloxy group.

The olefin-based polymer block preferably contains a (meth)acrylic polymer block having a repeating unit represented by the following general formula (IV) (sometimes simply referred to as “repeating unit (IV)”).

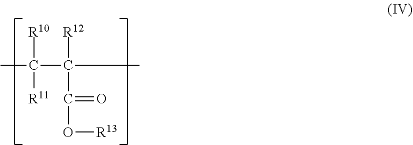

In the formula (IV), R¹⁰, R¹¹, R¹², and R¹³ each independently represent a hydrogen atom, an alkyl group having 1 to 6 carbon atoms, or an aryl group having 6 to 12 carbon atoms. The repeating unit (IV) corresponds to a case in which A¹ in the formula (II) represents a carbonyloxy group, and specific examples of the alkyl group having 1 to 6 carbon atoms and the aryl group having 6 to 12 carbon atoms in R¹⁰, R¹¹, R¹², and R¹³ similarly include those given for R¹, R², R³, and R⁴ in the formula (II).

In the formula (IV), R¹⁰ and R¹¹ each preferably represent a hydrogen atom, and R¹² preferably represents a hydrogen atom or a methyl group. Further, R¹³ in the formula (IV) preferably represents an alkyl group having 1 to 6 carbon atoms, more preferably represents a methyl group, an ethyl group, a n-propyl group, or a n-butyl group, still more preferably represents a methyl group or an ethyl group, and still further more preferably represents a methyl group. The alkyl group having 1 to 6 carbon atoms, which is represented by R¹³, may have a hydroxy group.

The olefin-based polymer block has a repeating unit derived from a polymerizable unsaturated monomer serving as a raw material for the repeating unit (II). The polymerizable unsaturated monomer is represented by the following general formula (2).

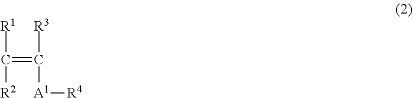

In the formula (2), R¹, R², R³, R⁴, and A¹ are as described above.

Any one of the known monomers may be used as the polymerizable unsaturated monomer as long as the monomer is a radical-polymerizable unsaturated monomer that can form the olefin-based polymer block. Examples of the polymerizable unsaturated monomer include a (meth)acrylic monomer, a vinyl monomer, and a vinyl ester monomer.

The polymerizable unsaturated monomers may be used alone or in combination thereof.

The (meth)acrylic monomer preferably includes at least one selected from (meth)acrylic acid, an alkyl (meth)acrylate, a hydroxy group-containing alkyl (meth)acrylate, and an aryl (meth)acrylate. Herein, the term “(meth)acrylic” means “acrylic” or “methacrylic”. In addition, the term “(meth)acrylate” means “acrylate” or “methacrylate”.

Examples of the (meth)acrylic monomer include (meth)acrylic acid, methyl (meth)acrylate, ethyl (meth)acrylate, n-butyl (meth)acrylate, isobutyl (meth)acrylate, tert-butyl (meth)acrylate, 2-ethylhexyl (meth)acrylate, benzyl (meth)acrylate, phenoxyethyl (meth)acrylate, cyclohexyl (meth)acrylate, 2-hydroxyethyl (meth)acrylate, 3-hydroxypropyl (meth)acrylate, 4-hydroxybutyl (meth)acrylate, phenyl (meth)acrylate, and naphthyl (meth)acrylate.

Examples of the vinyl monomer include an aliphatic hydrocarbon-based vinyl monomer, an alicyclic hydrocarbon-based vinyl monomer, and an aromatic hydrocarbon-based vinyl monomer.

Examples of the aliphatic hydrocarbon-based vinyl monomer include ethylene, propylene, butene, isobutylene, and pentene.

Examples of the alicyclic hydrocarbon-based vinyl monomer include cyclohexene, cyclopentadiene, dicyclopentadiene, pinene, limonene, vinylcyclohexene, and ethylidene bicycloheptene.

Examples of the aromatic hydrocarbon-based vinyl monomer include styrene, α-methylstyrene, α-ethylstyrene, vinyltoluene, 2,4-dimethylstyrene, 4-ethylstyrene, 4-isopropylstyrene, 4-butylstyrene, 4-phenylstyrene, 4-cyclohexylstyrene, 4-benzylstyrene, p-methylstyrene, and vinylnaphthalene.

Examples of the vinyl ester monomer include vinyl acetate and vinyl propionate.

The content ratio of the repeating unit (IV) in all the repeating units (II) is preferably from 20 mass % to 100 mass %, more preferably from 50 mass % to 100 mass %, still more preferably from 80 mass % to 100 mass %, still further more preferably from 95 mass % to 100 mass %.

### Constituent Unit Represented by Formula (III)

The carbonate-(meth)acrylic copolymer of the present invention includes the constituent unit represented by the following general formula (III) (sometimes simply referred to as “constituent unit (III)”).

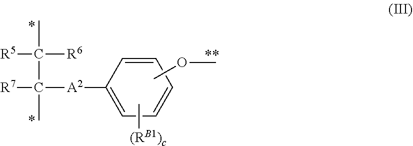

In the formula (III), R⁵, R⁶, and R⁷ each independently represent a hydrogen atom, an alkyl group having 1 to 6 carbon atoms, or an aryl group having 6 to 12 carbon atoms, R^{B1} represents a halogen atom, an alkyl group having 1 to 6 carbon atoms, or an alkoxy group having 1 to 6 carbon atoms, and “c” represents an integer of from 0 to 4,

Specific examples of R⁵, R⁶, and R⁷ may include the same examples as those of R¹⁰, R¹¹, and R¹² in the formula (IV), and preferred examples thereof are also the same as those of R¹⁰, R¹¹, and R¹². Specific examples of R^{B1} may include the same examples as those of R^{A1} and R^{A2} described above, and preferred examples thereof are also the same as those of R^{A1} and R^{A2}. “c” has the same meaning as that of each of “a” and “b”, and a preferred value thereof is also the same as those of “a” and “b”.

In the formula (III), at least one of bonding sites each represented by * is bonded to the olefin-based polymer block, and a bonding site represented by ** is bonded to the polycarbonate block.

In the formula (III), A² represents a single bond or a divalent group represented by the following formula (III-d).

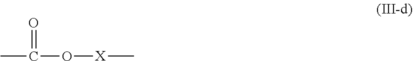

In the formula (III-d), X represents a single bond, an alkyleneoxy group having 1 to 12 carbon atoms, an arylene group having 6 to 12 carbon atoms, a divalent group represented by the following formula (III-a), or a divalent group represented by the following formula (III-b).

In the formula (III-d), the free bonding site of a carbonyl group (site that can be bonded to any other group) is bonded to a carbon atom bonded to R⁷ in the general formula (III). In the formula (III-d), the free bonding site of X is bonded to a benzene ring bonded to A² in the general formula (III).

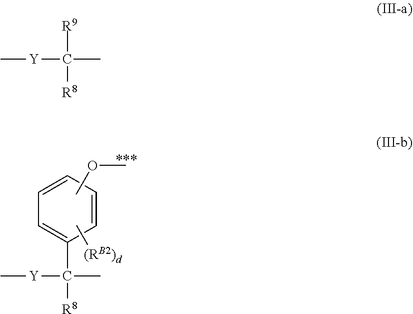

In the formula (III-b), R^{B2} represents a halogen atom, an alkyl group having 1 to 6 carbon atoms, or an alkoxy group having 1 to 6 carbon atoms, “d” represents an integer of from 0 to 4, and a bonding site represented by *** is bonded to the polycarbonate block, or is bonded to a hydrogen atom or a monovalent organic group.

Although the monovalent organic group bonded to the bonding site in *** is not particularly limited, examples thereof include: a monovalent group derived from a monohydric phenol given as an example of the terminal stopper; and an acyl group serving as a protecting group for a phenolic hydroxy group. The acyl group is, for example, an acyl group derived from an alkyl monocarboxylic acid having 1 to 6 carbon atoms.

In each of the formulae (III-a) and (III-b), the free bonding site of Y is bonded to an oxygen atom bonded to X in the general formula (III-d). In each of the formulae (III-a) and (III-b), the free bonding site of a carbon atom is bonded to the benzene ring bonded to A² in the repeating unit represented by the general formula (III).

In the formulae (III-a) and (III-b), R⁸ and R⁹ each independently represent a hydrogen atom, an alkyl group having 1 to 6 carbon atoms, or an aryl group having 6 to 12 carbon atoms. Examples of the alkyl group having 1 to 6 carbon atoms, which is represented by any one of R⁸ and R⁹, include a methyl group, an ethyl group, a n-propyl group, an isopropyl group, various butyl groups, various pentyl groups, and various hexyl groups. The alkyl group having 1 to 6 carbon atoms, which is represented by any one of R⁸ and R⁹, may be linear or branched, but is preferably linear. Examples of the aryl group having 6 to 12 carbon atoms, which is represented by any one of R⁸ and R⁹, include a phenyl group, a biphenyl group, and a naphthyl group. Each of R⁸ and R⁹ preferably represents a hydrogen atom or a methyl group, and more preferably represents a methyl group.

In each of the formulae (III-a) and (III-b), Y represents a single bond, an alkylene group having 1 to 12 carbon atoms, or a divalent group represented by the following formula (III-c).

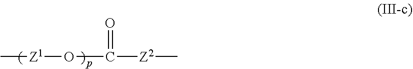

In the formula (III-c), Z¹ represents an alkylene group having 1 to 12 carbon atoms, Z² represents a single bond or an alkylene group having 1 to 12 carbon atoms, and “p” represents an integer of from 1 to 10. The alkylene group having 1 to 12 carbon atoms, which is represented by any one of Z¹ and Z², may be linear or branched, and examples thereof include a methylene group, an ethylene group, a propylene group, and a butylene group. Among them, a methylene group and an ethylene group are preferred, and an ethylene group is more preferred. “p” represented in the formula (III-c) preferably represents an integer of from 1 to 6, more preferably represents an integer of from 1 to 4, and still more preferably represents an integer of 1 or 2.

In the formula (III-c), the free bonding site of Z¹ is bonded to the oxygen atom bonded to X in the formula (III-d). In the formula (III-c), the free bonding site of Z² is bonded to a carbon atom bonded to Y in each of the formulae (III-a) and (III-b).

The constituent unit represented by the general formula (III) is preferably such a constituent unit that A² in the formula (III) represents a divalent group represented by the general formula (III-d) from the viewpoint of introducing the olefin-based polymer block into a polycarbonate chain, and is more preferably such a constituent unit that X in the formula (III-d) represents a divalent group represented by the formula (III-b). The constituent unit represented by the formula (III) is still more preferably a constituent unit represented by the following formula (III-1) (sometimes simply referred to as “constituent unit (III-1)”).

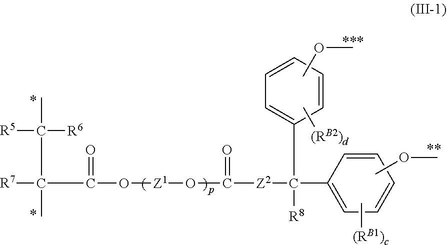

In the formula (III-1), R⁵, R⁶, R⁷, R⁸, R^{B1}, R^{B2}, Z¹, Z², “c”, “d”, “p”, *, **, and *** each have the same meaning as that described above.

The constituent unit represented by the formula (III-1) refers to such a constituent unit that A² in the general formula (III) represents a divalent group represented by the formula (III-d), X represented in the formula (III-d) represents a divalent group represented by the formula (III-b), and Y represented in the formula (III-b) represents a divalent group represented by the formula (III-c).

The constituent unit (III) is not particularly limited, but is derived from a polymerizable unsaturated monomer having a phenolic hydroxy group (hereinafter sometimes referred to as “modified unsaturated monomer”). The modified unsaturated monomer is represented by the following general formula (3).

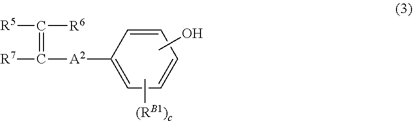

In the formula (3), R⁵, R⁶, R⁷, A², R^{B1}, and “c” are as described above. When A² in the general formula (3) represents a divalent group represented by the formula (III-d), and X in the formula (III-d) represents a divalent group represented by the formula (III-b), the formula (III-b) in the formula (3) is replaced with the following formula (3-b).

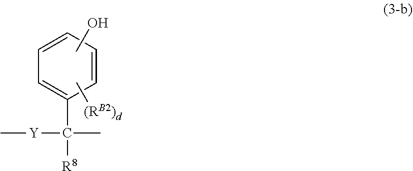

In the formula (3-b), R⁸, Y, R^{B2}, and “d” are as described above.

The modified unsaturated monomer is preferably a modified (meth)acrylic monomer. Herein, the modified (meth)acrylic monomer refers to such a modified unsaturated monomer that A² in the formula (3) represents a divalent group represented by the formula (III-d).

Examples of the modified (meth)acrylic monomer include an esterification reaction product of a hydroxy group-containing (meth)acrylic monomer and a carboxy group-containing phenol derivative, and hydroxyaryl (meth)acrylates, such as hydroxyphenyl (meth)acrylate.

Examples of the hydroxy group-containing (meth)acrylic monomer include 2-hydroxyethyl (meth)acrylate, 2-hydroxypropyl (meth)acrylate, 3-hydroxypropyl (meth)acrylate, and 4-hydroxybutyl (meth) acrylate.

Examples of the carboxy group-containing phenol derivative include p-hydroxyphenylacetic acid, p-hydroxyphenylpropionic acid, p-hydroxyphenylbutanoic acid, hydroxybenzoic acid, hydroxyphenylbenzoic acid, hydroxyphenoxybenzoic acid, and diphenolic acid.

The modified (meth)acrylic monomer is preferably represented by the following formula (3-1). The modified (meth)acrylic monomer represented by the following formula (3-1) is a modified (meth)acrylic monomer when the constituent unit (III) is the constituent unit (III-1).

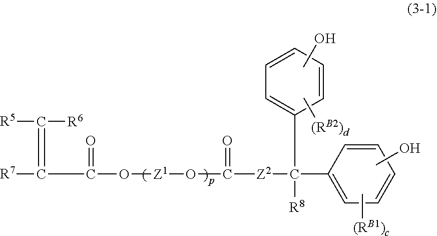

In the formula (3-1), R⁵, R⁶, R⁷, R⁸, R^{B1}, R^{B2}, Z¹, Z², “c”, “d”, and “p” are as described above.

Examples of the modified unsaturated monomer except the modified (meth)acrylic monomer include vinylphenols, such as 4-vinylphenol, 3-vinylphenol, and 2-vinylphenol.

### Modified Olefin-Based Polymer

Although a method of introducing the constituent unit (III) into the carbonate-olefin-based copolymer is not particularly limited, for example, the following method is preferred: the polymerizable unsaturated monomer forming the olefin-based polymer block and the modified unsaturated monomer are caused to react with each other to provide a modified olefin-based polymer; and then the modified olefin-based polymer and a polycarbonate having the repeating unit represented by the general formula (I) are caused to react with each other to provide the copolymer. In the modified olefin-based polymer, the olefin-based polymer block having the repeating unit (II) and the constituent unit (III) derived from the modified unsaturated monomer only need to be linked to each other, and a modification site in the modified olefin-based polymer is as follows: both terminals of the polymer may be modified, one terminal thereof may be modified, or a side chain thereof may be modified. In this description, the modified olefin-based polymer obtained by using the modified (meth)acrylic monomer as the polymerizable unsaturated monomer is sometimes referred to as “modified (meth)acrylic polymer”.

Although a method of producing the modified olefin-based polymer is not particularly limited, the modified olefin-based polymer may be obtained by, for example, copolymerizing the modified unsaturated monomer and the polymerizable unsaturated monomer through the use of an appropriate radical polymerization initiator. At this time, an organic solvent may be used as required. Any other monomer copolymerizable with the polymerizable unsaturated monomer and the modified unsaturated monomer may be used as a monomer of the modified olefin-based polymer.

Examples of the radical polymerization initiator include azo compounds, such as 2,2′-azobisisobutyronitrile (AIBN) and 2,2′-azobis(2,4-dimethylvaleronitrile), benzoyl peroxide, hydrogen peroxide, cumene hydroperoxide, tert-butyl hydroperoxide, di-tert-butyl peroxide, potassium persulfate, sodium persulfate, and ammonium persulfate. The radical polymerization initiators may be used alone or in combination thereof.

Such an amount that the polycarbonate block and the olefin-based polymer block are compatible with each other at the time of the production of the carbonate-olefin-based copolymer only needs to be appropriately selected as the usage amount of the modified unsaturated monomer. Specifically, the usage amount is preferably from 0.01 mol % to 20 mol %, more preferably from 0.1 mol % to 2 mol %, still more preferably from 0.15 mol % to 1.5 mol %, still further more preferably from 0.2 mol % to 1 mol % with respect to the total amount of the monomers to be used as raw materials.

The usage amount of the radical polymerization initiator varies depending on the kind of the initiator to be used. However, when the amount of the initiator is small, the polymerization ratio of the monomers tends to reduce, and when the amount of the initiator is large, the molecular weight of the copolymer tends to be small. Accordingly, the amount is preferably from 0.0001 part by mass or more to 5 parts by mass or less, more preferably from 0.0001 part by mass or more to 4 parts by mass or less, still more preferably from 0.001 part by mass or more to 3 parts by mass or less with respect to 100 parts by mass of the total amount of the monomers to be used.

The organic solvent that may be used in the polymerization of the modified olefin-based polymer is not particularly limited as long as the monomer serving as a raw material, the polymer to be produced, and the initiator can be dissolved therein, and examples thereof include toluene, xylene, dioxane, ethylene glycol monomethyl ether, butyl acetate, ethyl acetate, methyl isobutyl ketone, and methyl ethyl ketone.

The modified olefin-based polymer has the repeating unit (II) and the constituent unit (III).

The number-average molecular weight (Mn) of the modified olefin-based polymer is preferably from 3,000 to 50,000, more preferably from 4,000 to 30,000, still more preferably from 5,000 to 20,000. The Mn of the modified olefin-based polymer is calculated by gel permeation chromatography (GPC) measurement through the use of a polymethyl methacrylate (PMMA) as a standard substance, and may be measured by a method described in Examples to be described later.

### Method of Producing carbonate-olefin-based Copolymer

A method of producing the carbonate-olefin-based copolymer of the present invention is not particularly limited. When the polycarbonate block is produced by an interfacial polymerization method, the production method preferably includes, for example, a step (1) of causing a dihydric phenol and a carbonate precursor, such as phosgene, to react with each other to produce a polycarbonate oligomer forming the polycarbonate block, and a step (2) of causing the polycarbonate oligomer, a dihydric phenol, a terminal stopper, and the modified olefin-based polymer to react with each other to produce the carbonate-olefin-based copolymer.

The reaction between the dihydric phenol and the carbonate precursor in the step (1) is not particularly limited; a known method may be adopted, and the reaction is preferably performed by the interfacial polymerization method in the presence of an inert organic solvent. The reaction may be performed in the presence of a polymerization catalyst as required, and the reaction is preferably performed in the presence of the polymerization catalyst. An alkaline aqueous solution of the dihydric phenol is preferably used as the dihydric phenol.

A reaction temperature in the step (1) is selected from the range of typically from 0° C. to 80° C., preferably from 5° C. to 70° C.

### Polymerization Catalyst

A phase-transfer catalyst is suitable as the polymerization catalyst, and for example, a tertiary amine or a salt thereof, a quaternary ammonium salt, or a quaternary phosphonium salt may be preferably used.

Examples of the tertiary amine include triethylamine, tributylamine, N,N-dimethylcyclohexylamine, pyridine, and dimethylaniline. Examples of the tertiary amine salt include hydrochlorides and bromates of those tertiary amines. Examples of the quaternary ammonium salt include trimethylbenzylammonium chloride, triethylbenzylammonium chloride, tributylbenzylammonium chloride, trioctylmethylammonium chloride, tetrabutylammonium chloride, and tetrabutylammonium bromide. Examples of the quaternary phosphonium salt include tetrabutylphosphonium chloride and tetrabutylphosphonium bromide. The polymerization catalysts may be used alone or in combination thereof.

Among the polymerization catalysts, tertiary amines are preferred, and triethylamine is particularly suitable.

### Organic Solvent

An inert organic solvent is suitable as the organic solvent, and for example, a chlorinated hydrocarbon, toluene, or acetophenone may be preferably used.

Examples of the chlorinated hydrocarbon include dichloromethane (methylene chloride), trichloromethane, carbon tetrachloride, 1,1-dichloroethane, 1,2-dichloroethane, 1,1,1-trichloroethane, 1,1,2-trichloroethane,1,1,1,2-tetrachloroethane, 1,1,2,2-tetrachloroethane, pentachloroethane, and chlorobenzene. The organic solvents may be used alone or in combination thereof. Among the organic solvents, dichloromethane is particularly suitable.

The usage amount of the organic solvent is typically selected so that a volume ratio between an organic phase and an aqueous phase may be preferably from 5/1 to 1/7, more preferably from 2/1 to 1/4.

### Alkaline Aqueous Solution

Examples of the alkaline aqueous solution may include aqueous solutions of alkaline inorganic compounds including; alkali metal hydroxides, such as sodium hydroxide and potassium hydroxide; and alkaline earth metal hydroxides, such as magnesium hydroxide and calcium hydroxide. Among them, an aqueous solution of an alkali metal hydroxide is preferred, and an aqueous solution of sodium hydroxide or potassium hydroxide is more preferred.

In normal cases, a solution having an alkali concentration of from 1 mass % to 15 mass % is preferably used as the alkaline aqueous solution into which the dihydric phenol is dissolved. The amount of the dihydric phenol in the alkaline aqueous solution is typically selected from the range of from 0.5 mass % to 20 mass %.

The step (2) is a step of causing the dihydric phenol, the polycarbonate oligomer obtained in the step (1), the modified olefin-based polymer, and the terminal stopper to react with each other. The reaction in the step (2) is not particularly limited; a known method may be adopted, and the reaction is performed in the presence of an inert organic solvent. The reaction may be performed in the presence of a polymerization catalyst as required, and the reaction is preferably performed in the presence of the polymerization catalyst. An alkaline aqueous solution of the dihydric phenol is preferably used as the dihydric phenol. The polycarbonate oligomer obtained in the step (1) is preferably used under the state of being mixed with the inert organic solvent, in other words, as a polycarbonate oligomer solution in the step (2), and an inert organic solvent phase containing the polycarbonate oligomer obtained in the step (1) is more preferably used as it is. Examples of the dihydric phenol, the alkaline aqueous solution, and the polymerization catalyst include the same examples as those described above, and preferred examples thereof are also the same as those described above. The terminal stopper is used after having been dissolved in the inert organic solvent so that its concentration may be preferably from 2 mass % to 20 mass %, more preferably from 4 mass % to 15 mass %, still more preferably from 4 mass % to 12 mass %.

In the step (2), the materials are subjected to interfacial polymerization at a reaction temperature in the range of typically from 0° C. to 50° C., preferably from 20° C. to 40° C.

The total content of the repeating unit (II) and a moiety derived from an alkenyl group of the constituent unit (III) in the carbonate-olefin-based copolymer of the present invention is preferably from 5 mass % to 90 mass %, more preferably from 7 mass % to 50 mass %, still more preferably from 10 mass % to 40 mass %.

The moiety derived from the alkenyl group of the constituent unit (III) means a moiety derived from a residue obtained by removing phenol structures in the general formula (3) and the formula (3-b) from the structure of the modified unsaturated monomer represented by the general formula (3). The total content of the repeating unit (II) and the moiety derived from the alkenyl group of the constituent unit (III) may be calculated by a method described in Examples to be described later.

The ratio of the constituent unit (III) to the total of the repeating unit (II) and the constituent unit (III) in the carbonate-olefin-based copolymer of the present invention is preferably from 0.01 mol % to 20 mol %, more preferably from 0.1 mol % to 2 mol %, still more preferably from 0.15 mol % to 1.5 mol %, still further more preferably from 0.2 mol % to 1 mol %.

The molar ratio [constituent unit (III)/repeating unit (I)] of the constituent unit represented by the general formula (III) to the repeating unit represented by the general formula (I) in the carbonate-olefin-based copolymer of the present invention is preferably from 0.1/99.9 to 50/50, more preferably from 0.3/99.7 to 30/70, still more preferably from 0.5/99.5 to 10/90.

The viscosity-average molecular weight of the carbonate-olefin-based copolymer of the present invention is preferably from 10,000 to 80,000, more preferably from 15,000 to 30,000, still more preferably from 18,000 to 25,000 in terms of its mechanical characteristics and moldability.

In the present invention, the viscosity-average molecular weight (Mv) is calculated from the following Schnell's equation by using a limiting viscosity [η] determined through the measurement of the viscosity of a methylene chloride solution (concentration: g/L) at 20° C. with an Ubbelohde-type viscometer.

[η]=1.23×10⁻⁵ Mv^{0.83}

The number of repetitions of the repeating unit (I) in the carbonate-olefin-based copolymer of the present invention is preferably from 29 to 79, more preferably from 39 to 74, still more preferably from 49 to 69. When the number of repetitions of the repeating unit (I) falls within the range, a balance between the mechanical characteristics and the moldability becomes more suitable.

### Resin Composition

The carbonate-olefin-based copolymer of the present invention may be turned into a thermoplastic resin composition further including a thermoplastic resin except the copolymer.

Examples of the thermoplastic resin include a polycarbonate resin, a styrene-based resin, a polyethylene resin, a polypropylene resin, a polymethyl methacrylate resin, a polyvinyl chloride resin, a cellulose acetate resin, a polyamide resin, a polyester resin (e.g., PET or PBT), polylactic acid and/or a copolymer containing polylactic acid, a polyacrylonitrile resin, an acrylonitrile-butadiene-styrene resin (ABS resin), a polyphenylene oxide resin (PPO), a polyketone resin, a polysulfone resin, a polyphenylene sulfide resin (PPS), a fluorine resin, a silicon resin, a polyimide resin, a polybenzimidazole resin, and a polyamide elastomer, and copolymers thereof with other monomers.

The ratio of the carbonate-olefin-based copolymer in the thermoplastic resin composition is preferably 85 mass % or more, more preferably 90 mass % or more, still more preferably 95 mass % or more, still further more preferably 97 mass % or more, particularly preferably 99 mass % or more from the viewpoint of obtaining higher scratch resistance.

The carbonate-olefin-based copolymer of the present invention may be turned into a resin composition having added and incorporated thereinto an additive component, which has been commonly used in a thermoplastic resin, as required. Examples of the additive component include a plasticizer, a stabilizer, an inorganic filler, a flame retardant, a silicone-based compound, and a fluorine resin. The blending amount of the additive component is not particularly limited as long as the amount falls within such a range that the characteristics of the polycarbonate-olefin-based copolymer of the present invention are maintained.

The resin composition including the carbonate-olefin-based copolymer of the present invention is obtained by blending the thermoplastic resin at an arbitrary ratio and any other additive component at an arbitrary ratio, and kneading the blend at a temperature of from about 200° C. to about 350° C. The blending and the kneading at this time may be performed by a method involving premixing with a typically used apparatus, such as a ribbon blender or a drum tumbler, and using, for example, a Henschel mixer, a Banbury mixer, a single-screw extruder, a twin-screw extruder, a multi-screw extruder, or a Ko-kneader. In normal cases, a heating temperature at the time of the kneading is appropriately selected from the range of from 240° C. to 330° C.

### Molded Article

A molded article of the present invention includes the carbonate-olefin-based copolymer of the present invention. The molded article may be produced by, for example, an injection molding method, an injection compression molding method, an extrusion molding method, a blow molding method, a press molding method, a vacuum molding method, or an expansion molding method through the use of a molten kneaded product containing the carbonate-olefin-based copolymer or a pellet obtained through the melt kneading of the copolymer as a raw material. In particular, the molded article is preferably produced by the injection molding method or the injection compression molding method through the use of the resultant pellet.

The pencil hardness of the molded article of the present invention is preferably H or more, more preferably 211 or more. When the pencil hardness is less than H, the surface of the molded article tends to be liable to flaw. In the present invention, a pencil hardness of H or more can be achieved with the carbonate-olefin-based copolymer of the present invention. In the present invention, the pencil hardness is measured in conformity with ISO/DIN 15184:2012.

The total light transmittance of the molded article of the present invention is preferably 80% or more, more preferably 82% or more, still more preferably 85% or more. In the present invention, the total light transmittance is measured in conformity with JIS K 7361-1:1997.

The molded article including the carbonate-olefin-based copolymer of the present invention may be used in a wide variety of fields, and is useful in various applications, such as: electrical and electronic equipment, and parts therefor; OA equipment; information terminal equipment; machine parts; household electric appliances; vehicle parts; building members; various containers; lighting equipment; playing tools; and sundries.

### EXAMPLES

The present invention is more specifically described by way of Examples below. However, the present invention is not limited to these Examples.

In Examples and Comparative Examples, physical properties were measured and evaluated by the following methods.

### (1) Viscosity-average Molecular Weight

The viscosity of a dichloromethane solution at 20° C. was measured with an Ubbelohde-type viscometer. A limiting viscosity [η] was determined from the resultant value, and a viscosity-average molecular weight (Mv) was calculated from the equation [η]=1.23×10⁻⁵ Mv^{0.83}.

### (2) Assignment of Modified (Meth)acrylic Monomer

The ¹-NMR of a sample dissolved in deuterated chloroform was measured, and the structure of a modified (meth)acrylic monomer represented by the formula (3-1), which had been produced in Production Example below, was assigned.

### <¹H-NMR Measurement Conditions>

Nuclear magnetic resonance (NMR) apparatus: “ECA500” manufactured by JEOL RESONANCE Inc.

Probe: 50TH5AT/FG2

Observed range: −5 ppm to 15 ppm

Observation center: 5 ppm

Pulse repetition time: 9 sec

Pulse width: 45°

NMR sample tube: 5 mmφ

Sample amount: 30 mg to 40 mg

Solvent: deuterated chloroform

Measurement temperature: room temperature

Number of scans: 256 times

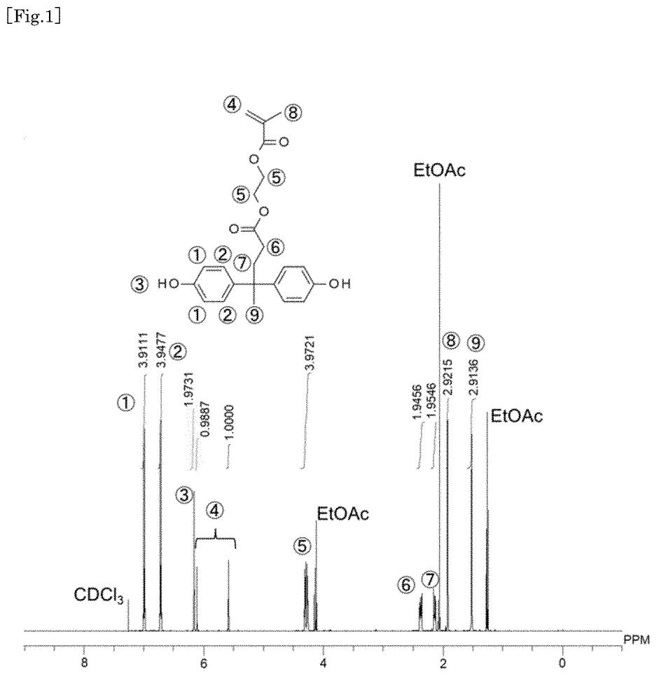

An NMR chart is shown in FIG. 1.

### (3-1) Assignment of Structure of Modified (Meth)acrylic Polymer

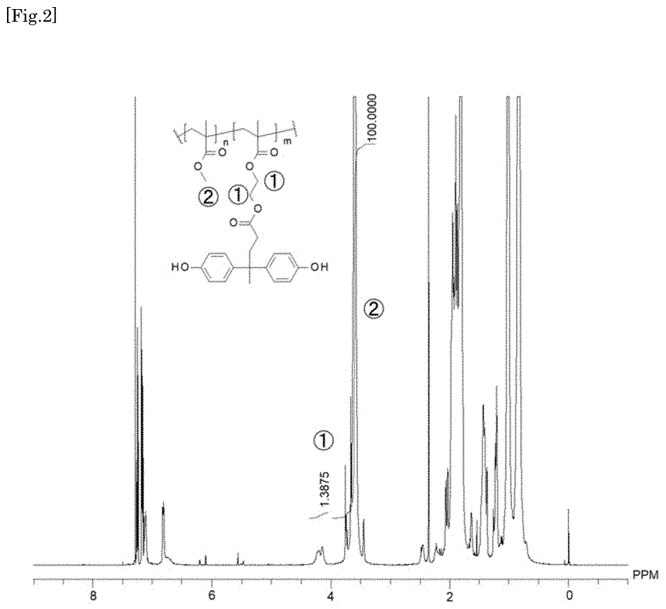

The ¹H-NMR of a sample dissolved in deuterated chloroform was measured with “ECA500” manufactured by JEOL RESONANCE Inc. under the same measurement conditions as those described above, and the structure of a modified (meth)acrylic polymer having a repeating unit (IV) and a constituent unit represented by the formula (III-1), which had been produced in each of Production Examples below, was assigned. An NMR chart is shown in FIG. 2.

(3-2) Content of Constituent Unit represented by Formula (III-1)

The content of the constituent unit (III-1) in the modified (meth)acrylic polymer was determined from the integrated values (i) and (ii) of the following two peaks by using the following equation in consideration of the number of protons. Encircled numbers 1 and 2 shown in FIG. 2 correspond to the integrated values (i) and (ii), respectively.
(i) The integrated value of an oxymethylene group of a modified (meth)acrylic monomer moiety observed at a 6 of from about 4.0 to about 4.4
(ii) The integrated value of a methyl ester group of a methyl methacrylate (MMA) moiety observed at a 6 of from about 3.2 to about 4.0 Content (mol %) of constituent unit (III-1)=[((i)/4)/((i)/4+(ii)/3)]×100
   (4-1) Assignment of Structure of carbonate-olefin-based Copolymer

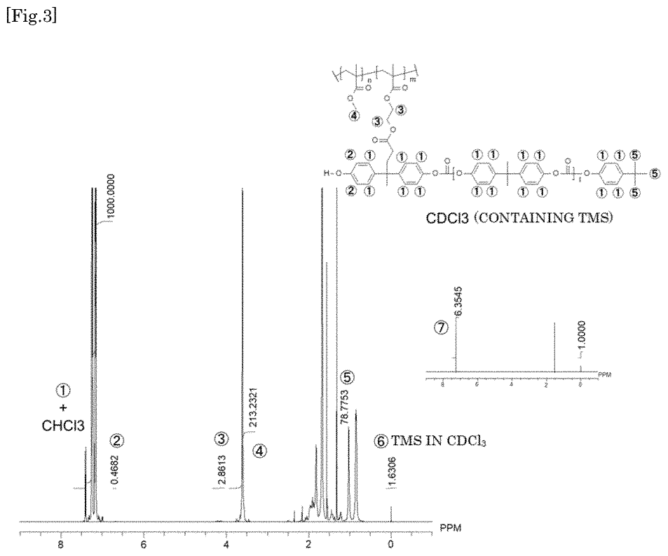

The ¹H-NMR of a sample dissolved in deuterated chloroform was measured with “ECA500” manufactured by JEOL RESONANCE Inc. under the same measurement conditions as those described above, and the structure of a carbonate-olefin-based copolymer was assigned. An NMR chart is shown in FIG. 3.

(4-2) Total Content of Repeating Unit (II) and Moiety derived from alkenyl Group of Constituent Unit (III) in Copolymer

The content in the carbonate-olefin-based copolymer was determined from the integrated values (i) to (vii) of the following peaks by using the following equation in consideration of the number of protons. Encircled numbers 1 to 7 shown in FIG. 3 correspond to the integrated values (i) to (vii), respectively.
(i) The integrated value of a phenyl group of a bisphenol A (BPA) moiety observed at a δ of from about 6.8 to about 7.7
(ii) The integrated value of the hydroxy group-terminated phenyl group of the BPA moiety observed at a δ of from about 6.6 to about 6.8
(iii) The integrated value of an oxymethylene group of a modified (meth)acrylic monomer moiety observed at a δ of from about 4.0 to about 4.4
(iv) The integrated value of a methyl ester group of a methyl methacrylate (MMA) moiety observed at a δ of from about 3.2 to about 4.0
(v) The integrated value of the butyl group of a 4-t-butylphenol (PTBP) moiety observed at a δ of from about 1.2 to about 1.4
(vi) The integrated value of a trimethylsilyl group (TMS) in deuterated chloroform observed at a δ of from about −0.2 to about 0.2
(vii) The integrated value of chloroform in deuterated chloroform observed at a 6 of from about 7.0 to about 7.5 when the integrated value of the TMS at the time of the measurement of only deuterated chloroform is set to 1
a=(iii)/4
b=(iv)/3
c=(v)/9
d=[(i)+(ii)·a×8·c×4·(vi)×(vii)]/8
T=a+b+c+d
Modified (meth)acrylic monomer residue (mol %) A=a/T×100
MMA residue (mol %) B=b/T×100
PTBP residue (mol %) C=c/T×100
BPA residue (mol %) D=d/T×100
Modified (meth)acrylic monomer residue (mass %)=A×424/TW×100
MMA residue (mass %)=B×100/TW×100
PTBP residue (mass %)=C×149/TW×100
BPA residue (mass %)=D×254/TW×100
TW=A×424+B×100+C×149+D×254

The total content (mass %) of the repeating unit (II) and the moiety derived from the alkenyl group of the constituent unit (III) in the copolymer is calculated from the total sum of the modified (meth)acrylic monomer residue amount (mass %) and the MMA residue amount (mass %).

### (4-3) Molar Ratio of Constituent Unit (III) to Repeating Unit (I)

The ratio of the modified (meth)acrylic monomer residue amount (mol %) to the BPA residue amount (mol %) is calculated.

(5) Measurement of Molecular Weight (Mn) of Modified (meth)acrylic Polymer

10 mg of a modified (meth)acrylic polymer was dissolved in 10 mL of tetrahydrofuran (THF), and its number-average molecular weight (Mn) was measured with a gel permeation chromatography (GPC) apparatus set to the following conditions.

Apparatus; GPC system manufactured by Tosoh Corporation (HLC-8220)

Detector; RI detector

Column; TSKgel G4000HXL+G2000HXL

Standard substance; polymethyl methacrylate (manufactured by Agilent Technologies, Inc.)

Eluent; THF, 1.0 mL/min

Injection amount; 0.1 mL

### (6) Measurement of Glass Transition Temperature (Tg)

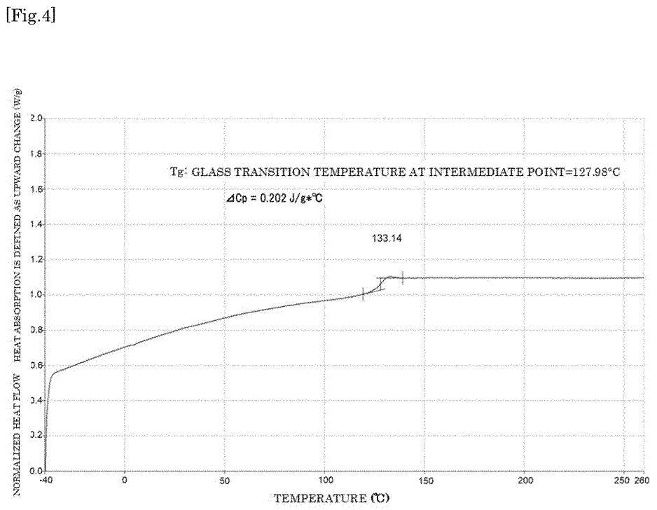

3.90 mg of a sample was loaded into an aluminum-made sample container, and was subjected to DSC measurement with a differential scanning calorimeter (Diamond DSC, PerkinElmer) as follows: the sample was cooled to −40° C. and held at the temperature for 5 minutes; the sample was heated from −40° C. to 260° C. at a rate of temperature increase of 20° C./min, and was held at 260° C. for 1 minute; the sample was cooled from 260° C. to −40° C. at a rate of temperature decrease of 20° C./min, and was held at −40° C. for 5 minutes; and the sample was heated to 260° C. at a rate of temperature increase of 20° C./min. The glass transition temperature of the sample was determined from a peak at the time of the second temperature increase in the resultant DSC curve. The DSC curve of a carbonate-olefin-based copolymer produced in Example 1 is shown in FIG. 4.

### (7) Evaluation of Scratch Resistance

Scratch resistance was evaluated by the following method.

### (a) Production of Molded Piece

A resin (including a mixture of a plurality of resins) was loaded into a small kneader (manufactured by PSM, product name: Micro (15 cc) Twin Screw Compounder 10 cc) at from 240° C. to 300° C., and was then kneaded for 1.5 minutes. After that, the sample was subjected to injection molding with a small injection molding machine (manufactured by PSM, product name: Micro (12 cc) Injection Molding Machine) under the conditions of an injection pressure of 1 MPa and an injection time of 20 seconds. A cylinder temperature was set to the same temperature as the kneading temperature of the Compounder, and a mold temperature was set to 40° C. As a result, a dumbbell-shaped molded body (ISO dumbbell piece) measuring 150 mm long by 10 mm wide by 4 mm thick was obtained.

### (b) Measurement of Pencil Hardness

The pencil hardness of the ISO dumbbell piece produced in the foregoing was measured at a load of 750 g with a pencil hardness tester in accordance with JIS K 5600-5-4:1999 (ISO/DIN 15184:2012), followed by the evaluation of its scratch resistance.

### (8) Measurement of Total Light Transmittance

The total light transmittance of an ISO dumbbell piece produced by the same method as that in the (7) was measured with a haze meter “NDH-5000” manufactured by Nippon Denshoku Industries Co., Ltd. in accordance with JIS K 7361-1:1997.

### Synthesis Example 1: Synthesis of Modified (Meth)acrylic Monomer

100 mg (0.9 mmol) of hydroquinone was loaded into a 300-milliliter recovery flask including an ice bath, a stirrer, and a stirring bar, and the inside of the flask was purged with nitrogen. 100 mL of ethyl acetate, 7.3 mL (60 mmol) of 2-hydroxyethyl methacrylate, and 5.1 mL (66 mmol) of methanesulfonyl chloride were added to the contents with a syringe, and the flask was immersed in the ice bath, followed by stirring. 9.2 mL (66 mmol) of triethylamine was dropped to the mixture, and after the dropping, the whole was continuously stirred at 0° C. for 2 hours.

After the stirring, the resultant solution was collected in a separating funnel, and was washed with a saturated sodium chloride solution. After that, an organic phase was obtained. The organic phase was dehydrated with sodium sulfate, and then the solvent was evaporated. Thus, an oily substance was obtained. 100 mg (0.9 mmol) of hydroquinone and 30 mL of dimethylformamide were added to the oily substance to provide a solution. Thus, a solution of the oily substance in dimethylformamide was obtained.

17.8 g (63 mmol) of diphenolic acid and 6.6 g (79 mmol) of sodium hydrogen carbonate were loaded into a 300-milliliter recovery flask including an oil bath, a stirrer, and a stirring bar, and the inside of the flask was purged with nitrogen. 150 mL of dimethylformamide was added to the contents with a syringe, and the mixture was warmed to 80° C. The solution of the oily substance in dimethylformamide obtained in the foregoing was added to the mixture, and the whole was continuously stirred at 80° C. for 10 hours.

After the stirring, the resultant solution was collected in a separating funnel, and was washed with a saturated sodium chloride solution. After that, an organic phase was obtained. The organic phase was dehydrated with sodium sulfate, and then the solvent was evaporated. Thus, a crude product was obtained. The crude product was purified by column chromatography (solvents: n-hexane and ethyl acetate) to provide a yellow viscous oil. It was judged from structural analysis by NMR that the oil was a target modified (meth)acrylic monomer shown in FIG. 1.

### Production Example 1: Synthesis of Modified (Meth)acrylic Polymer

30 mL of dehydrated toluene, 375 mg of the modified (meth)acrylic monomer produced in Synthesis Example 1, 10 mL of methyl methacrylate (MMA), and 54 mg of an azo initiator AIBN were loaded into a 100-milliliter recovery flask including an oil bath, a cooling tube, a stirrer, and a stirring bar, and were continuously stirred at 75° C. for 6 hours.

The slurry-like reaction liquid was loaded into 1 L of methanol to precipitate a polymer. The precipitated polymer was separated and recovered by suction filtration, and was dried in a vacuum at 100° C. for 5 hours to provide a modified (meth)acrylic polymer.

The NMR measurement of the resultant polymer showed that the ratio of a structure derived from the modified (meth)acrylic monomer to a structure derived from methyl methacrylate was 1.2/98.8 (mol/mol). In addition, the molecular weight Mn of the polymer in terms of PMMA measured by GPC was 18,900.

### Production Example 2: Production of Modified (Meth)acrylic Polymer

A modified (meth)acrylic polymer was obtained by the same method as that of Production Example 1 except that, in Production Example 1, the usage amount of the azo initiator AIBN was changed from 54 mg to 108 mg.

The NMR measurement of the resultant polymer showed that the ratio of a structure derived from the modified (meth)acrylic monomer to a structure derived from methyl methacrylate was 1.2/98.8 (mol/mol). In addition, the molecular weight Mn of the polymer in terms of PMMA measured by GPC was 15,000.

### Production Example 3: Synthesis of Modified (Meth)acrylic Polymer

A modified (meth)acrylic polymer was obtained by the same method as that of Production Example 1 except that, in Production Example 1, the usage amount of the modified (meth)acrylic monomer was changed from 375 mg to 135 mg.

The NMR measurement of the resultant polymer showed that the ratio of a structure derived from the modified (meth)acrylic monomer to a structure derived from methyl methacrylate was 0.6/99.4 (mol/mol). In addition, the molecular weight Mn of the polymer in terms of PMMA measured by GPC was 18,800.

### Production Example 4: Production of Polycarbonate Oligomer

2,000 ppm by mass of sodium dithionite with respect to bisphenol A to be dissolved later was added to 5.6 mass % aqueous sodium hydroxide. Then, bisphenol A was dissolved in the mixture. Thus, a solution of bisphenol A in aqueous sodium hydroxide having a bisphenol A concentration of 13.5 mass % was prepared.

The solution of bisphenol A in aqueous sodium hydroxide, methylene chloride, and phosgene were continuously passed through a tubular reactor having an inner diameter of 6 mm and a tube length of 30 m at flow rates of 40 L/hr, 15 L/hr, and 4.0 kg/hr, respectively. The tubular reactor had a jacket portion and the temperature of the reaction liquid was kept at 40° C. or less by passing cooling water through the jacket.

The reaction liquid that had exited the tubular reactor was continuously introduced into a baffled vessel type reactor provided with a sweptback blade and having an internal volume of 40 L. The solution of bisphenol A in aqueous sodium hydroxide, 25 mass % aqueous sodium hydroxide, water, and a 1 mass % aqueous solution of triethylamine were further added to the reactor at flow rates of 2.8 L/hr, 0.07 L/hr, 17 L/hr, and 0.64 L/hr, respectively, to perform a reaction. An aqueous phase was separated and removed by continuously taking out the reaction liquid overflowing the vessel type reactor and leaving the reaction liquid at rest. Then, a methylene chloride phase was collected.

The resultant polycarbonate oligomer solution (methylene chloride solution) had a concentration of 347 g/L and a chloroformate group concentration of 0.71 mol/L.

### Example 1: Carbonate-olefin-based Copolymer

235 mL of the polycarbonate oligomer (PCO) solution produced in Production Example 4 and 439 mL of methylene chloride were loaded into a 1-liter tank-type reactor including a baffle board, a paddle-type stirring blade, and a cooling jacket, and 40.8 g of the modified (meth)acrylic polymer produced in Production Example 1 wad loaded into the mixture, and was dissolved therein by stirring. 6.7 g of a 1 mass % solution of triethylamine in methylene chloride was loaded into the solution under stirring at 100 rpm, and then 20.8 g of 6.4 mass % aqueous sodium hydroxide was added to the mixture, followed by stirring for 10 minutes at 400 rpm. Further, 38.1 g of a 10 mass % solution of p-t-butylphenol in methylene chloride (10 mass % PTBP solution) and an alkaline aqueous solution of bisphenol A (obtained by dissolving 13.3 g of bisphenol A in 135.3 g of 6.4 mass % aqueous sodium hydroxide) were added to the resultant, and the mixture was stirred for 50 minutes at 500 rpm.

The stirring was stopped, and the solution was left at rest to be separated into an organic phase containing a copolymer, and an aqueous phase containing excessive amounts of bisphenol A and sodium hydroxide, and the organic phase was isolated.

The organic phase was sequentially washed with 0.03 mol/L aqueous sodium hydroxide and 0.2 mol/L hydrochloric acid in amounts of 15 vol % each with respect to the solution. Next, the washed product was repeatedly washed with pure water so that an electric conductive in an aqueous phase after the washing became 0.1 mS/m or less.

The resultant solution of the carbonate-olefin-based copolymer in methylene chloride was concentrated, and was then pulverized. The resultant flake was dried under reduced pressure at 100° C.

The viscosity-average molecular weight (Mv) of the flake was measured. As a result, the Mv was 22,100.

NMR measurement showed that the total content of a repeating unit (II) and a moiety derived from an alkenyl group of a constituent unit (III) in the carbonate-olefin-based copolymer was 34.9 mass %.

The glass transition temperature of the copolymer was measured by DSC. As a result, as shown in FIG. 4, a single peak appeared and the glass transition temperature was 127.98° C.

The viscosity-average molecular weight, pencil hardness, and total light transmittance of the resultant carbonate-olefin-based copolymer are shown in Table 1.

### Examples 2 and 3: Carbonate-olefin-based Copolymers

Carbonate-olefin-based copolymers were each obtained by the same method as that of Example 1 except that, in Example 1, the modified (meth)acrylic polymer of Production Example 2 or 3 shown in Table 1 was used instead of the modified (meth)acrylic polymer produced in Production Example 1, and the addition amount of the 10 mass % PTBP solution was changed to a value shown in Table 1. The molar ratio of a constituent unit (III) to a repeating unit (I), a viscosity-average molecular weight, the total content of a repeating unit (II) and a moiety derived from an alkenyl group of the constituent unit (III) in a copolymer, a pencil hardness, and a total light transmittance are shown in Table 1 for each of the resultant carbonate-olefin-based copolymers.

TABLE 1

| | | | Unit | Example 1 | Example 2 | Example 3 |
|---|---|---|---|---|---|---|
| Modified (meth)acrylic polymer | | Kind | — | Production | Production | Production |
| | | | | Example 1 | Example 2 | Example 3 |
| | | Loading | g | 40.8 | 40.8 | 40.8 |
| | | amount | | | | |
| 10 mass % PTBP solution | | Addition | g | 38.1 | 34.3 | 20.2 |
| | | amount | | | | |
| Copolymer | Molar ratio “constituent unit | | — | 1.4/98.6 | 1.2/98.8 | 0.5/99.5 |
| | (IIII/repeating unit (I)” | | | | | |
| | Viscosity average molecular weight | Mv | — | 22,100 | 19,700 | 23,000 |
| | Total content of (II) and moiety | | mass % | 34.9 | 30.6 | 30.7 |
| | derived from alkenyl group of (III)*¹ | | | | | |
| | Pencil hardness | Molded | — | 2H | 2H | 2H |
| | | piece | | | | |

| | | | | |
|---|---|---|---|---|
| Total light transmittance | % | 87 | 90 | 91 |

*¹The total content of a repeating unit (II) and a moiety derived from an alkenyl group of a constituent unit (III) in a copolymer

### Comparative Examples 1 to 3

Molded pieces were each produced by using a resin or a resin mixture shown in Table 2, and their pencil hardnesses and total light transmittances were measured. The results are shown in Table 2.

The resins used in Comparative Examples 1 to 3 are as described below.

FN2200 (manufactured by Idemitsu Kosan Co., Ltd., product name: TARFLON FN2200, linear polycarbonate having an My of 21,300)

H-880 (manufactured by Mitsubishi Chemical Corporation, product name: METABLEN H-880, acrylic resin) 80N (manufactured by Asahi Kasei Corporation, product name: DELPET 80N, methacrylic resin)

TABLE 2

| | | | Comparative | Comparative | Comparative |
|---|---|---|---|---|---|
| | | Unit | Example 1 | Example 2 | Example 3 |
| Polycarbonate | FN2200 | Part(s) by mass | 70 | 70 | 100 |
| (Meth)acrylic polymer | 80N | Part(s) by mass | 30 | — | — |
| | H-880 | Part(s) by mass | — | 30 | — |
| Viscosity average | Mv | — | — | — | 21,300 |
| molecular weight | | | | | |
| Pencil hardness | Molded | — | H | F | 2B |
| | piece | | | | |

| | | | | |
|---|---|---|---|---|
| Total light transmittance | % | Opaque | 90 | 92 |

### INDUSTRIAL APPLICABILITY

The carbonate-olefin-based copolymer of the present invention has excellent scratch-resisting performance while retaining excellent characteristics of a polycarbonate. Accordingly, the copolymer is suitably used in molded articles required to have the above-mentioned characteristics in an automobile field, a household electric appliance field, an electronic equipment field, a food field, and a building material field.

1. A carbonate-olefin-based copolymer, comprising:
a polycarbonate block having a repeating unit represented by the following general formula (I);
an olefin-based polymer block having a repeating unit represented by the following general formula (II); and
a constituent unit represented by the following general formula (III): 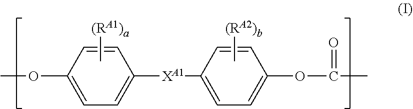
wherein
in the formula (I), R^{A1} and R^{A2} each independently represent a halogen atom, an alkyl group having 1 to 6 carbon atoms, or an alkoxy group having 1 to 6 carbon atoms, X^{A1} represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, and “a” and “b” each independently represent an integer of from 0 to 4, and when a plurality of R^{A1}s or R^{A2}s are present, the plurality of R^{A1}s or R^{A2}s may be identical to or different from each other; 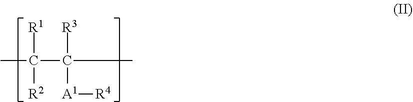
wherein
in the formula (II), R¹, R², R³, and R⁴ each independently represent a hydrogen atom or a hydrocarbon group having 1 to 12 carbon atoms, and A¹ represents a single bond, a carbonyloxy group, or an oxycarbonyl group; 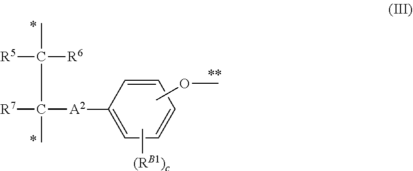
wherein
in the formula (III), R⁵, R⁶, and R⁷ each independently represent a hydrogen atom, an alkyl group having 1 to 6 carbon atoms, or an aryl group having 6 to 12 carbon atoms, R^{B1} represents a halogen atom, an alkyl group having 1 to 6 carbon atoms, or an alkoxy group having 1 to 6 carbon atoms, “c” represents an integer of from 0 to 4, A² represents a single bond or a divalent group represented by the following formula (III-d), at least one of bonding sites each represented by * is bonded to the olefin-based polymer block, and a bonding site represented by ** is bonded to the polycarbonate block; 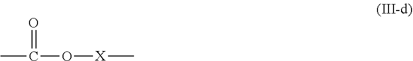
wherein
in the formula (III-d), X represents a single bond, an alkyleneoxy group having 1 to 12 carbon atoms, an arylene group having 6 to 12 carbon atoms, a divalent group represented by the following formula (III-a), or a divalent group represented by the following formula (III-b); 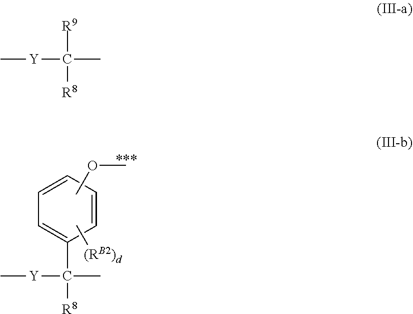
wherein
in the formulae (III-a) and (III-b), R⁸ and R⁹ each independently represent a hydrogen atom, an alkyl group having 1 to 6 carbon atoms, or an aryl group having 6 to 12 carbon atoms, Y represents a single bond, an alkylene group having 1 to 12 carbon atoms, or a divalent group represented by the following formula (III-c), R^{B2} represents a halogen atom, an alkyl group having 1 to 6 carbon atoms, or an alkoxy group having 1 to 6 carbon atoms, “d” represents an integer of from 0 to 4, and a bonding site represented by *** is bonded to the polycarbonate block, or is bonded to a hydrogen atom or a monovalent organic group; 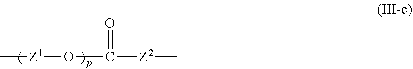
wherein
in the formula (III-c), Z¹ represents an alkylene group having 1 to 12 carbon atoms, Z² represents a single bond or an alkylene group having 1 to 12 carbon atoms, and “p” represents an integer of from 1 to 10.

2. The carbonate-olefin-based copolymer according to claim 1, wherein a total content of the repeating unit represented by the general formula (II) and a moiety derived from an alkenyl group of the constituent unit represented by the general formula (III) in the carbonate-olefin-based copolymer is from 5 mass % to 90 mass %.

3. The carbonate-olefin-based copolymer according to claim 1, wherein a ratio of the constituent unit represented by the general formula (III) to a total of the repeating unit represented by the general formula (II) and the constituent unit represented by the general formula (III) is from 0.01 mol % to 20 mol %.

4. The carbonate-olefin-based copolymer according to claim 1, wherein a molar ratio of the constituent unit represented by the general formula (III) to the repeating unit represented by the general formula (I) is from 0.1/99.9 to 50/50.

5. The carbonate-olefin-based copolymer according to claim 1, wherein the constituent unit represented by the general formula (III) is represented by the following formula (III-1): 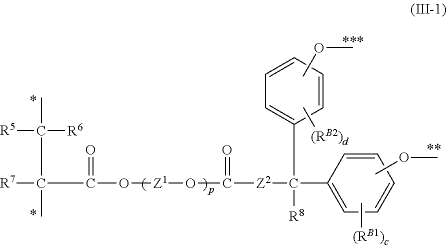
wherein
in the formula (III-1), R⁵, R⁶, R⁷, R⁸, R^{B1}, R^{B2}, Z¹, Z², “c”, “d”, “p”, *, **, and *** each have the same meaning as that described above.

6. The carbonate-olefin-based copolymer according to claim 1, wherein the olefin-based polymer block contains a (meth)acrylic polymer block having a repeating unit represented by the following general formula (IV): 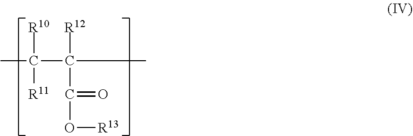
wherein
in the formula (IV), R¹⁰, R¹¹, R¹², and R¹³ each independently represent a hydrogen atom, an alkyl group having 1 to 6 carbon atoms, or an aryl group having 6 to 12 carbon atoms.

7. The carbonate-olefin-based copolymer according to claim 1, wherein the carbonate-olefin-based copolymer has a viscosity-average molecular weight of from 10,000 to 80,000.

8. The carbonate-olefin-based copolymer according to claim 1, wherein a number of repetitions of the repeating unit represented by the general formula (I) in the carbonate-olefin-based copolymer is from 29 to 79.

9. The carbonate-olefin-based copolymer according to claim 1, wherein the carbonate-olefin-based copolymer comprises a copolymer of a modified olefin-based polymer having the repeating unit represented by the general formula (II) and the constituent unit represented by the general formula (III), and a polycarbonate having the repeating unit represented by the general formula (I).

10. The carbonate-olefin-based copolymer according to claim 9, wherein the modified olefin-based polymer has a number-average molecular weight (Mn) of from 3,000 to 50,000.

11. A molded article, comprising the carbonate-olefin-based copolymer of claim 1.
